(19) United States
(12) Patent Application Publication
(10) Pub. No.: US 2026/0001340 A1
(43) Pub. Date: Jan. 1, 2026

(54) CARTRIDGE PACKAGE AND MANUFACTURING METHOD FOR CARTRIDGE PACKAGE

(71) Applicant: CANON KABUSHIKI KAISHA, Tokyo (JP)

(72) Inventors: TATSUO NANJO, Kanagawa (JP); SOJI KONDO, Kanagawa (JP); HIROSHI KOSHIKAWA, Kanagawa (JP); KEISUKE IINUMA, Kanagawa (JP); HIROSHI YAMADA, Kanagawa (JP)

(21) Appl. No.: 19/244,549

(22) Filed: Jun. 20, 2025

(30) Foreign Application Priority Data
Jun. 28, 2024 (JP) 2024-104683

(51) Int. Cl. B41J 2/175; B65D 5/20; B65D 5/42; B65D 81/05

(52) U.S. Cl. CPC B41J 2/17533; B41J 2/17536; B65D 81/05; B65D 5/20; B65D 5/4208

(57) ABSTRACT

Disclosed is a cartridge package that includes a cartridge for mounting on a liquid ejection apparatus and to reserve liquid; a storage container arranged with a bottom and at least four side walls, and including a main body and a film, the main body including a storage portion configured to store the cartridge and an opening facing the bottom, the film being arranged to seal the opening; and a box including a substantially hexahedral housing portion for housing the storage container. In the box, a surface of the housing portion facing the film in a state in which the storage container is housed in the box includes an outer wall and an inner wall that is provided to be separated from the outer wall by a space.

### BACKGROUND

### Field of the Technology

The present disclosure relates to a package for a cartridge to be mounted in an ink-jet apparatus.

### Description of the Related Art

Serial type recording apparatuses such as ink-jet printers are known in which an image is formed on a recording medium by scanning a cartridge and conveying the recording medium by a predetermined amount in a direction perpendicular to a scanning direction. As a cartridge for this recording method, a head integrated type is known in which an element substrate for ejecting liquid serving as a recording material such as ink and a chamber that stores the ink are integrally configured. In the cartridge, a main body member includes an ink absorbing member storing ink therein, and an element substrate is attached to a lower portion of the cartridge in the direction of gravity. The ink stored in the ink absorbing member is guided through a filter and an ink flow path to the element substrate, and is ejected from the element substrate to form an image on a recording medium.

An ink-jet apparatus serving as a liquid ejection apparatus that ejects liquid such as ink from a liquid ejection head to perform desired recording is equipped with an ink tank for storing ink and a liquid ejection head that ejects the ink stored in the ink tank. Here, a type of ink-jet apparatus is known in which a liquid cartridge, such as an ink cartridge, which is an ink tank formed into a cartridge, and a liquid ejection head cartridge, which is a liquid ejection head formed into a cartridge, are separately mounted. A type of ink-jet apparatus is also known in which an ink cartridge with liquid ejection head, in which an ink tank and a liquid ejection head are integrated into a cartridge, is mounted.

During distribution, a liquid cartridge is stored in a storage container for the liquid cartridge after a seal or the like is applied to an ink supply port portion to a liquid ejection head. Further, a blister pack is often used as a storage container for a liquid cartridge.

Similarly, a liquid cartridge with a liquid ejection head is stored in a storage container for an ink cartridge with liquid ejection head after a seal or the like is applied to an ink ejection port of the liquid ejection head. Further, a blister pack is also often used as a storage container for an ink cartridge with liquid ejection head.

As discussed in Japanese Patent Application Laid-Open No. 2022-29848, in terms of suppressing evaporation of ink during distribution, a cartridge is sometimes distributed and sold in a state of a package in which the cartridge stored in a storage container is stored in an individual packaging box. An example of a conventional cartridge package 900 is described with reference to FIGS. 18 and 19. FIG. 18 is an exploded schematic diagram of a storage container 910 and an individual packaging box 800. FIG. 19 is a perspective view of the package 900 configured with the storage container 910 and the individual packaging box 800. The storage container 910 is configured with a rigid main body 911, which is a substantially hexahedron with one of its six faces being open, and a film-like lid 914. A cartridge 901 is stored inside the main body 911 from an opening thereof, and the opening of the main body 911 is sealed with the lid 914 to form the storage container 910. This configuration hermetically seals the cartridge 901, thereby suppressing evaporation of the ink inside the cartridge 901. A user can easily remove the cartridge 901 from the storage container 910 by peeling off the lid 914.

The storage container 910 is sold at a store in a state of the package 900 stored in an individual packaging box 800.

The individual packaging box 800 has a hanging hole 802 so that it can be hung from a hook on a shelf of a store to be displayed and sold.

In a case where the package 900 according to the conventional example is dropped from a left side surface 812 thereof during display or removal, in other words, in a case where the package 900 is dropped in a posture in which the lid 914 side hits a floor, the cartridge 901 can be damaged. In a case where the package 900 is dropped in this posture, only the film lid 914 and the paper individual packaging box 800 are interposed between the cartridge 901 and the floor. Both the lid 914 and the individual packaging box 800 are made of soft packaging materials, and a drop impact received from the floor is directly transmitted to the cartridge 901. The drop impact can damage the cartridge 901 and cause damage, such as ink leakage. In contrast, in a case where the package 900 is dropped in a posture with the lid 914 facing a direction other than downward, a hard packaging material of the main body 911 is interposed between the cartridge 901 and the floor. When the rigid main body 911 is interposed, an outer wall or a rib of the main body 911 may deform in response to an impact, absorb the impact, and act to protect the cartridge 901. The above-described posture dropping from the lid side is a severe posture in which the cartridge 901 receives a greater impact than other postures, and it is likely to be difficult to secure drop reliability. Countermeasures such as inserting a separate buffer material between the lid 914 and the individual packaging box 800 are possible, but have a disadvantage of increased costs.

### SUMMARY

According to an aspect of the present disclosure, a cartridge package includes a cartridge configured to be mounted on a liquid ejection apparatus and to store liquid; a storage container configured with a bottom, at least four side walls, a main body, and a film, the main body including a storage portion configured to store the cartridge and an opening facing the bottom, the film being configured to seal the opening; and a box including a substantially hexahedral housing portion configured to house the storage container. In a state in which the storage container is housed in the box, a surface of the housing portion facing the film includes an outer wall and an inner wall separated from the outer wall by a space.

Further features of the present disclosure will become apparent from the following description of exemplary embodiments with reference to the attached drawings.

### BRIEF DESCRIPTION OF THE DRAWINGS

FIG. 1A is a cross-sectional view of an ink cartridge with a liquid ejection head in a side direction. FIGS. 1B and 1C are perspective views of the ink cartridge.

FIG. 2 is a cross-sectional view of a storage container according to a first exemplary embodiment in the side direction.

FIG. 3A is a perspective view of the storage container and the ink cartridge with a liquid ejection head according to the first exemplary embodiment. FIGS. 3B and 3C are perspective views of the storage container according to the first exemplary embodiment.

FIGS. 4A to 4C are cross-sectional views of the storage container according to the first exemplary embodiment and the ink cartridge with liquid ejection head stored in the storage container in an upper surface direction.

FIGS. 5A and 5B are cross-sectional views of the storage container according to the first exemplary embodiment and the ink cartridge with liquid ejection head stored in the storage container in a front direction.

FIGS. 6A to 6D illustrate how ribs bend and exert an elastic effect when the storage container according to the first exemplary embodiment and the ink cartridge with liquid ejection head stored therein are dropped.

FIG. 7 is a cross-sectional view of the storage container according to the first exemplary embodiment and the ink cartridge with liquid ejection head stored in the storage container in the side direction.

FIG. 8 is an exploded perspective view of a package according to the first exemplary embodiment.

FIG. 9 is a perspective view of the package according to the first exemplary embodiment.

FIG. 10 is a cross-sectional view of the package according to the first exemplary embodiment.

FIG. 11 is a development view of an individual packaging box according to the first exemplary embodiment.

FIG. 12 is a schematic top view of the individual packaging box according to the first exemplary embodiment.

FIG. 13 is a perspective view of the individual packaging box according to the first exemplary embodiment.

FIGS. 14A and 14B are schematic diagrams illustrating a state where a storage container is inserted into an individual packaging box.

FIGS. 15A and 15B illustrate a buffering function when the package according to the first exemplary embodiment drops.

FIG. 16A is a perspective view of a storage container and a cartridge according to a second exemplary embodiment. FIG. 16B is a partially enlarged cross-sectional view of the storage container according to the second exemplary embodiment.

FIG. 17 illustrates a buffering function when a package according to the second exemplary embodiment drops.

FIG. 18 is an exploded view of a conventional package.

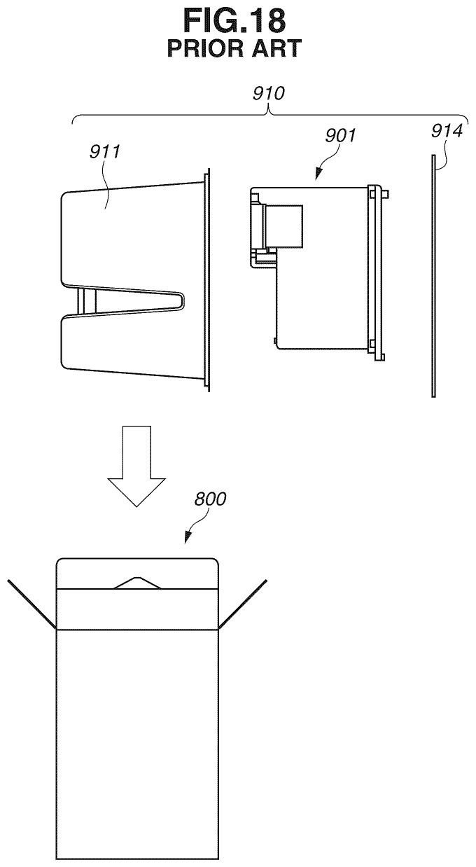

FIG. 19 is a perspective view of the conventional package.

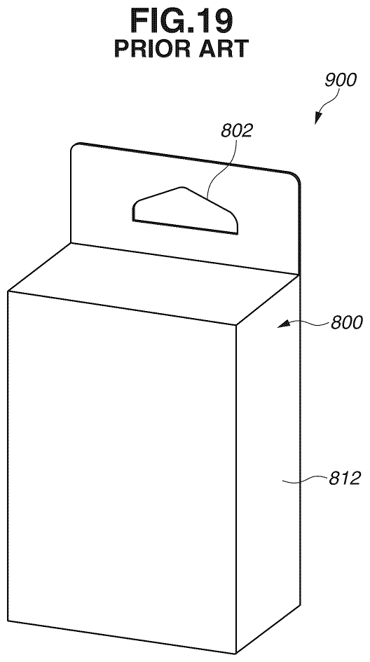

### DESCRIPTION OF THE EMBODIMENTS

Exemplary embodiments of the present disclosure will now be described in detail with respect to the attached drawings. However, constituent components described in the following exemplary embodiments can be appropriately modified in their dimensions, materials, shapes, and relative layout thereof depending on a configuration or various conditions of an apparatuses to which the present disclosure is applied. In other words, it is not intended to limit the scope of the present disclosure to the following exemplary embodiments.

A storage container according to the present exemplary embodiment is a storage container for a liquid ejection head in which the liquid ejection head is stored in a case where the liquid ejection head is distributed in the market. A package according to the present exemplary embodiment is also a package for a liquid ejection head and is a cartridge package. According to the present exemplary embodiment, a storage container for a liquid ejection head is described, but an object to be stored in the storage container is not limited to a liquid ejection head. For example, the storage container can be a storage container that stores a liquid cartridge for replenishing liquid into a liquid ejection head (ink-jet head) mounted on an ink-jet printer or a liquid cartridge that stores a liquid ejection head.

### Ink Cartridge

A first exemplary embodiment will now be described. In the following description, a height direction of a liquid cartridge is defined as a Z direction, a width direction of the liquid cartridge perpendicular to the Z direction is defined as an X direction, and a depth direction of the liquid cartridge perpendicular to the X and Z directions is defined as a Y direction, in a state where the liquid cartridge is mounted to a liquid ejection apparatus.

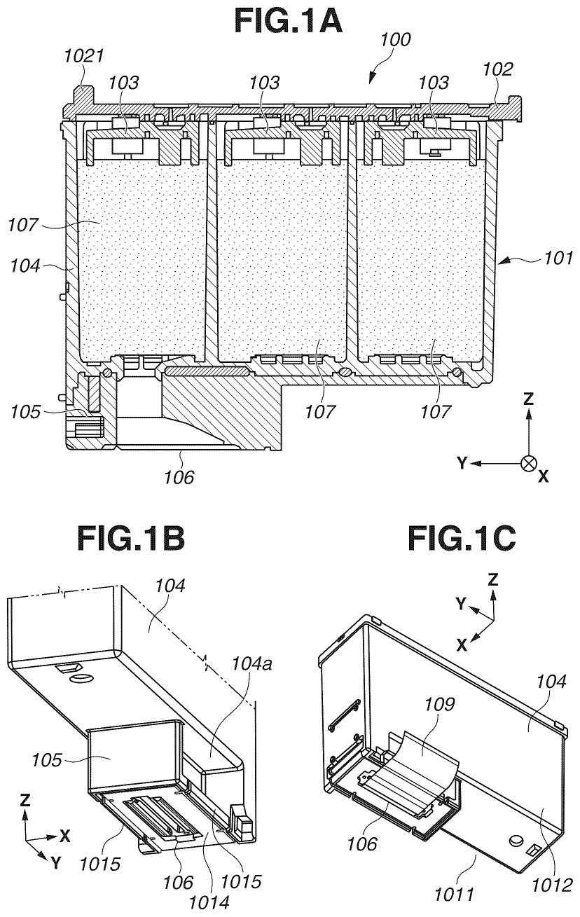

FIG. 1A is a cross-sectional view of an ink cartridge with liquid ejection head in a side direction. FIGS. 1B and 1C are perspective views of a liquid cartridge with liquid ejection head. An ink cartridge 100 with liquid ejection head (hereinbelow, referred to as “ink cartridge”) includes a tank case 101, a tank lid 102, and a rib plate 103. Here, the tank case 101 includes an ink reservoir chamber (reservoir portion) 104, a head portion 105, and an ejection substrate 106 provided with an ejection port. An upper portion (tank lid 102) of the ink cartridge 100 is provided with a protrusion such as an engagement portion 1021 for identifying stored liquid by matching with a structure of the liquid ejection apparatus.

The ink reservoir chamber 104 is filled with an absorbing member 107 that stores ink. The tank lid 102 has an air communication port formed thereon. The above-described rib plate 103 is arranged between the absorbing member 107 and the tank lid 102.

The head portion 105 is provided to be connected to a bottom of the ink reservoir chamber 104. A width of the head portion 105 is narrower than a width of the ink reservoir chamber 104, so that a bottom 104a is formed near a portion where the bottom of the ink reservoir chamber 104 is connected to the head portion 105. The ejection substrate 106 is connected to a lower tip end of the head portion 105. A head fixing surface 1014 on which the ejection substrate 106 is provided has head fixing portion side surfaces 1015 on both ends. The head fixing portion side surfaces 1015 are arranged on the inside (on the ink reservoir chamber 104 side in the X direction) of a first side surface 1011 and a second side surface 1012 of the ink cartridge 100.

Even if the ink cartridge 100 falls over, ink is retained by the absorbing member 107. During printing, the ink in the ink reservoir chamber 104 is ejected from the ejection port.

Before the ink cartridge 100 is stored in a storage container 110, which will be described below, a protection seal 109 is attached across the ejection substrate 106 and a lower end of the ink reservoir chamber 104 as illustrated in FIG. 1C.

### Storage Container for Ink Cartridge With Liquid Ejection Head

Next, the storage container 110 that stores the ink cartridge 100 according to the present disclosure (collectively referred to as “storage container”) will be described in detail.

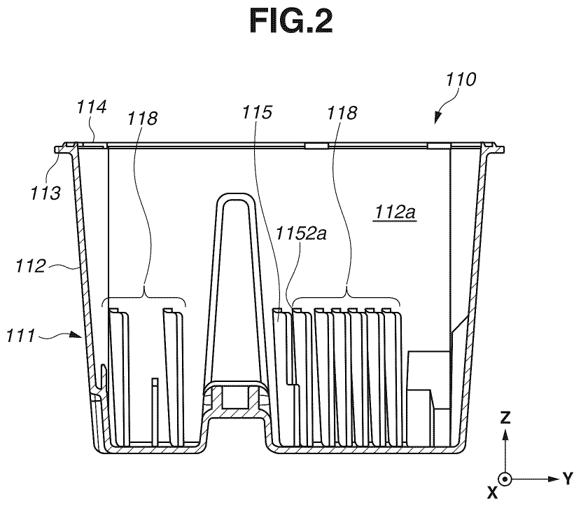

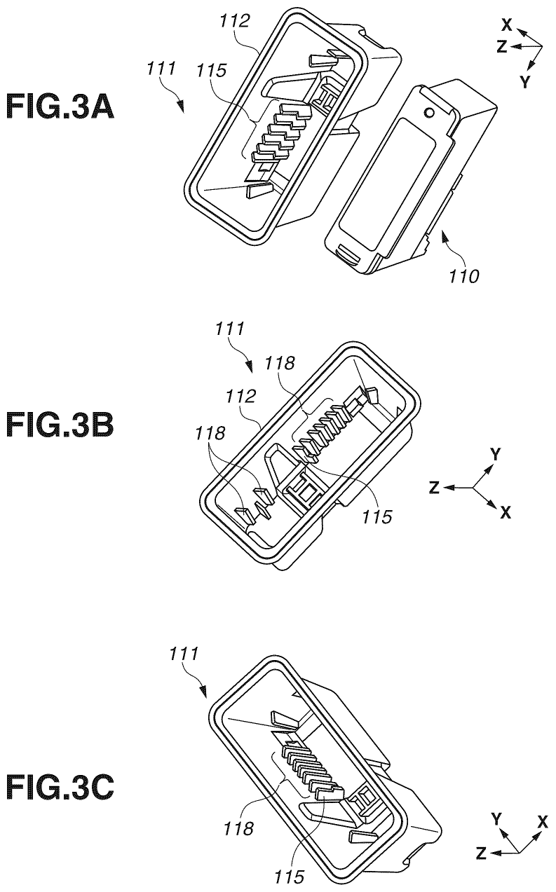

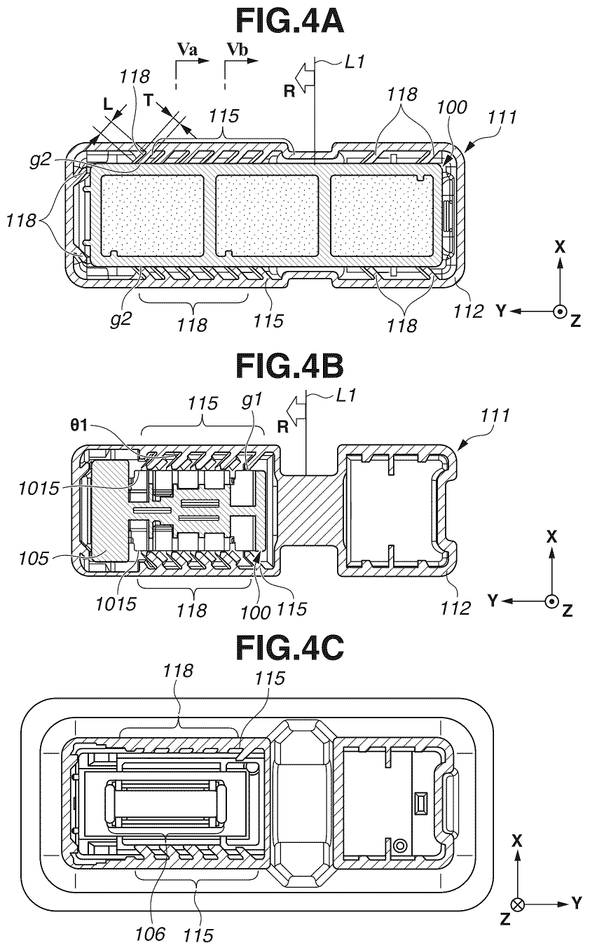

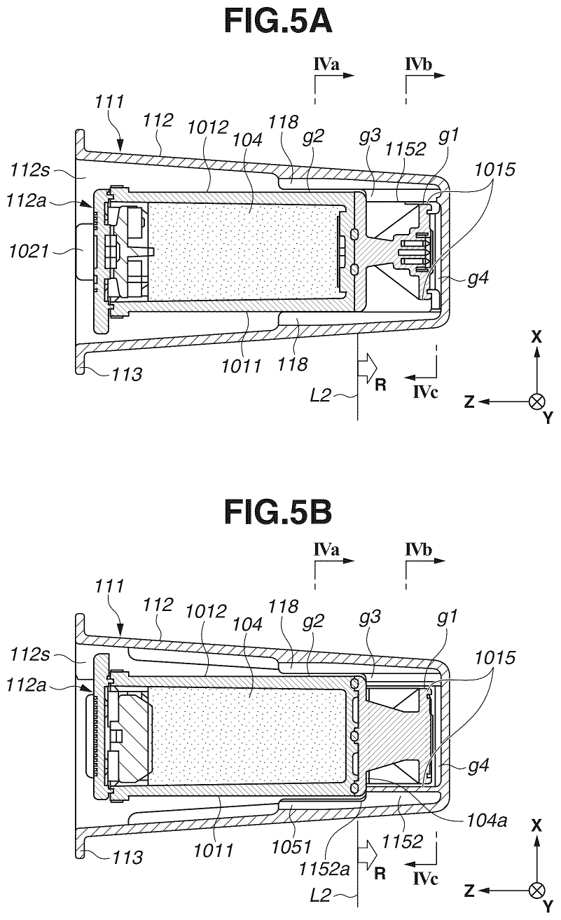

FIG. 2 is a cross-sectional view of the storage container 110 in the side direction. FIG. 3A is a perspective view of the storage container 110 and the ink cartridge 100. FIG. 3B is a perspective view of the storage container 110 as viewed from a different angle from that of FIG. 3A. FIG. 3C is a perspective view of the storage container 110 as viewed from a different angle from those of FIGS. 3A and 3B. FIG. 4A is a cross-sectional view of the storage container 110 and the ink cartridge 100 stored in the storage container 110 in an upper surface direction along a line IVa-IVa in FIG. 5A, which will be described below. FIG. 4B is a cross-sectional view in the upper surface direction along a line IVb-IVb in FIG. 5A. FIG. 4C is a cross-sectional view in the upper surface direction along a line IVc-IVc in FIG. 5A. FIG. 5A is a cross-sectional view in a front direction along a line Va-Va in FIG. 4A. FIG. 5B is a cross-sectional view in the front direction along a cross-sectional line Vb-Vb in FIG. 4A.

With reference to FIG. 2, the storage container 110 includes a main body (a container main body) 111 and a lid 114. The main body 111 includes a storage portion 112 that forms a storage space 112a for storing the ink cartridge 100 therein and a flange portion 113 extending from an opening portion of the storage portion 112 in an outer circumferential direction. The storage container 110 can store the ink cartridge 100 in the storage portion 112 from the upper surface direction of the storage portion 112 through the opening portion of the storage portion 112. The storage portion 112 of the main body 111 is configured with the bottom and at least four side walls. The ink cartridge 100 is stored inside the storage container 110, and thus an ink cartridge storage body 1000 is formed.

The ink cartridge 100 is stored in the storage portion 112, and then the lid 114 is joined to the flange portion 113, so that a sealed space is formed. According to the present exemplary embodiment, the lid 114 is a film, and a joint portion between the storage container 110 and the lid 114 is sealed by heat sealing (thermal welding), but other joining methods can also be used. According to the present exemplary embodiment, examples of a material of the lid 114 include a laminate film of a polyethylene terephthalate (PET) resin and polypropylene (PP). As a material of the storage container 110, PP is used. Materials of the lid 114 and the storage container 110 are not limited to those described above.

Recycled plastic can also be used as a material of the lid 114 and the main body 111.

A term “recycled plastic material” is used herein a broad sense to include a post-consumer recycled (PCR) material and a pre-consumer recycled material. According to the present disclosure, the recycled plastic material can be a PCR material or a pre-consumer recycled material. A mixture of both materials can also be used. The recycled plastic materials are made from raw materials that have experienced some degree of deterioration due to a thermal history during molding, and stress, heat, light, solvents, and the like during use. Due to these circumstances, recycled plastic materials are known to have different physical properties from virgin materials. For example, a recycled plastic material tends to have a poor shock absorbing capacity, in which molecular chains themselves inside the material bend to absorb a force when an impact is applied. This tendency can be seen in the Charpy impact test, and a molding material containing a recycled plastic material indicates lower impact strength than a virgin material. The deterioration in the shock absorbing capacity is due to a fact that original molecular chains have been cut by the above-described deterioration, and the shock absorbing effect of the molecular chains themselves is reduced.

Ribs included in the main body 111 will be described with reference to FIGS. 2, 3A to 3C, 4A to 4C, 5A, and 5B. Second ribs 118 and first ribs 115 are provided on inner side surfaces of the storage portion 112 of the main body 111. Hereinbelow, the second ribs 118 and the first ribs 115 are also collectively referred to as “ribs”. According to the present exemplary embodiment, the ribs are integrally molded with the main body 111. The ribs extend inward from the inner side surfaces of the storage portion 112. Specifically, the ribs protrude from the inner side surfaces of the storage portion 112 toward the storage space 112a. In other words, the ribs protrude in a first direction that is parallel to the bottom of the storage portion 112 and inclined with respect to the side wall of the storage portion 112.

The second rib 118 has a substantially constant protrusion length in a protrusion direction (XY plane direction). In contrast, the first rib 115 includes two portions having different protrusion lengths in the protrusion direction (XY plane direction), that is, the first rib 115 includes a first portion 1151 of which a protrusion length is substantially the same as that of the second rib 118 and a second portion 1152 of which a protrusion length is longer than that of the first portion 1151.

Both of the second ribs 118 and the first ribs 115 are inclined and provided at positions near the first side surface 1011 and the second side surface 1012 of the ink cartridge 100.

In a posture in which the ink cartridge 100 is stored in the storage portion 112, a gap g2 of a distance G2 is present on the XY plane between the first portion 1151 of the second rib 118 and the first rib 115 and the side surface of the ink cartridge 100. The second portion 1152 of the first rib 115 is provided at a position near the head fixing portion side surface 1015, and there is a gap g1 of distance G1 on the XY plane between the second portion 1152 and the head fixing portion side surface 1015. There is also a gap g3 (see FIGS. 5A and 5B) of distance G3 between the second rib 118 and the head fixing portion side surface 1015. The distance G2 is smaller than the distances G3 and G1, and in a state where the ink cartridge 100 is stored in the main body 111, the position of the ink cartridge 100 is regulated in the storage portion 112 by the second rib 118 and the first portion 1151. In other words, the second rib 118 and the first portion 1151 act as a position regulating portion for the ink cartridge 100.

As illustrated in FIGS. 4A to 4C, 5A, and 5B, the ink cartridge 100 occupies most of the storage space 112a when the ink cartridge 100 is stored in the storage portion 112. A gap space 112s is then formed between the storage portion 112 and the ink cartridge 100. The gap space 112s is a space excluding a portion occupied by the ink cartridge 100 from the storage space 112a.

Here, when looking at the cross-sectional view in the upper surface direction in FIG. 4A, the second ribs 118 and the first ribs 115 are inclined with respect to both the inner side surface of the storage portion 112 and an outer side surface of the ink cartridge 100. In other words, a direction in which each of the second ribs 118 and the first ribs 115 extends on the inner side surface includes a component inclined with respect to the outer surface of the ink cartridge 100 in a case where the ink cartridge 100 is stored in the storage portion 112, over an entire range in which the second ribs 118 and the first ribs 115 extend in the Z direction.

As illustrated in FIG. 4A, the ink cartridge 100 has a rectangular cross-sectional shape, the storage portion 112 also has a rectangular cross-sectional shape, and each side of the ink cartridge 100 is parallel to each side of the storage portion 112. Thus, directions in which the second ribs 118 and the first ribs 115 extend on the inner side surface on the XY plane include the component inclined with respect to the inner surface of the storage portion 112 in a case where the ink cartridge 100 is stored in the storage portion 112, over all the second ribs 118 and the first ribs 115. However, a single rib can have a configuration in which a portion having a component inclined with respect to the inner surface of the storage portion 112 and a portion not having a component inclined with respect to the inner surface of the storage portion 112 are mixed.

With reference to FIGS. 3A to 3C, 4A and 5A, in a case where the ink cartridge 100 is stored in the storage portion 112, the head portion 105 is stored in a head storage area R, which is on a left side of a line L1 in FIGS. 4A and 4B when viewed from above and is below a line L2 when viewed from the front. When looking at the cross-sectional view in FIG. 4A, the head storage area R is provided with five first ribs 115 and one second rib 118 above the ink cartridge 100, two second ribs 118 on the left of the ink cartridge 100, and six second ribs 118 and one first rib 115 below the ink cartridge 100. As illustrated in the cross-sectional views in FIGS. 4B and 4C, the head storage area R is provided with a total of six first ribs 115 on both side surfaces of the head fixing portion.

With reference to FIGS. 4A and 4B, the second ribs 118 and the first ribs 115 have a thickness T of 0.5 mm (millimeters) or more and 2.0 mm or less (a length in a direction perpendicular to an inward extending direction in the XY plane). The first ribs 115 may have a length L of 2.0 mm or more along the inward extending direction (the inward extending direction in the XY plane). According to the present exemplary embodiment, the length L is 2.8 mm as an example. As illustrated in FIGS. 5A and 5B, the length of the first rib 115 along the vertical extending direction (Z direction) is longer than a height of the head portion 105. As described below, a gap g4 can thereby be provided between the storage portion 112 and the ejection substrate 106 at the lower tip end of the head portion 105.

With reference to FIGS. 4A and 4B, an angle θ1 at which the extending direction (the inward extending direction in the XY plane) of the second ribs 118 and the first ribs 115 intersects with the inner side surface of the storage portion 112 is 30 degrees or more and 45 degrees or less. The angle θ1 may be 45 degrees. When the outer side surface of the ink cartridge 100 is parallel to the inner side surface of the storage portion 112, an angle at which the extending direction of the second ribs 118 and the first ribs 115 intersects with the outer side surface of the ink cartridge 100 may be 30 degrees or more and 45 degrees or less. The angle may also be 45 degrees.

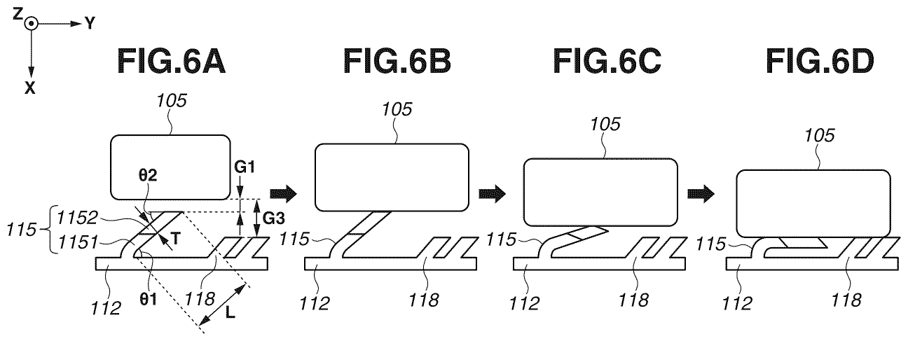

FIGS. 6A to 6D illustrate how the first rib 115 bends and exerts an elastic effect when the storage container 110 drops. When the storage container 110 storing the ink cartridge 100 drops to the ground or the like, the second portion 1152 of the first rib 115 comes into contact with the head portion 105 due to the impact as illustrated in FIGS. 6A to 6D. Since a plurality of the first ribs 115 is provided, the drop impact is dispersed in and received by a plurality of points, and the head portion 105 can be prevented from being significantly deformed locally. Since the first ribs 115 are inclined with respect to the ink cartridge 100 and the inner surface of the storage container 110, they have flexibility against an external force applied from the head portion 105 or the like and can buffer the drop impact by deforming. When an impact due to dropping is received, the head portion 105 comes into contact with the second portion 1152 of the first rib 115 as illustrated in FIG. 6B. When the head portion 105 is further displaced with respect to the storage portion 112 due to the impact, the first rib 115 bends while retaining its elasticity as illustrated in FIG. 6C. An elastic force of the first rib 115 increases as the first rib 115 bends more. Thus, the first ribs 115 absorb the impact even in a case where an impact occurs from the outside, and the impact applied on the head portion 105 can be reduced. Since the plurality of the first ribs 115 is provided, the impact applied per rib is reduced, and a deformation amount can be reduced, so that it is possible to buffer the drop impact and to prevent the ink cartridge 100 from coming into direct contact with the storage portion 112 (storage container inner wall) and receiving the impact.

In addition, the second ribs 118 and the first portion 1151 of the first rib 115 are arranged to avoid the head fixing surface 1014 and the head fixing portion side surface 1015. The drop impact is thereby not directly applied to the head portion 105, and thus the head portion 105 is less likely to be damaged.

When looking at the cross-sectional view in the FIG. 4C, the first ribs 115 provided to face the side surface of the ink cartridge 100 are arranged over almost the entire area of the ejection substrate 106 on which the ejection port is provided. In this way, the first ribs 115 are arranged over an area that is ⅔ or more of the length of the ejection substrate 106 in the side direction of the ink cartridge 100. The drop impact can thereby be dispersed in a length direction of the ejection substrate 106, and the head portion 105 and the ejection substrate 106 can be prevented from being significantly deformed and damaged due to a locally applied impact.

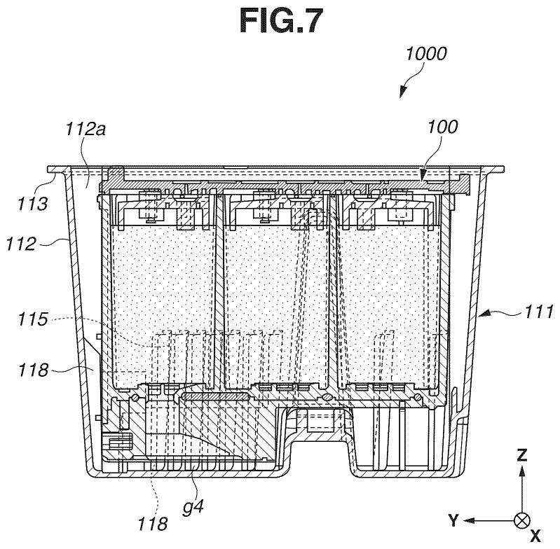

As illustrated in FIGS. 5A and 5B, when the ink cartridge 100 is stored in the storage portion 112, a height of the second portion 1152 of the first rib 115 is adjusted such that a top portion 1152a of the second portion 1152 of the first rib 115 supports the bottom 104a of the ink reservoir chamber 104 from below. In other words, the top portion 1152a is configured to support the bottom 104a of the ink reservoir chamber 104 from the head portion side. FIG. 7 is a cross-sectional view in the side direction of the storage container 110 and the ink cartridge 100 stored in the storage container 110. When the ink cartridge 100 is stored in the storage portion 112, the gap g4 exists between the ejection substrate 106 and the bottom of the storage portion 112 (see FIGS. 5A, 5B, and 7). The ejection substrate 106 can thereby be prevented from coming into contact with the bottom of the storage portion 112.

As described above, in a case where at least a certain level of dropping impact is externally applied, or the like, the second ribs 118 and the first ribs 115 disperse the impact in a plurality of points on the side surfaces of the ink cartridge 100 and prevent the impact from being directly applied to the head portion 105. In particular, the first ribs 115 regulate the position of the ink cartridge 100 with the first portions 1151 facing the side surfaces of the ink cartridge 100 while buffering the impact to the head portion 105 with the second portions 1152 facing the head portion 105.

Even in a case where a weight of the ink cartridge 100 is large, the second ribs 118 and the first portions 1151 of the first ribs 115 can disperse the impact in a plurality of points on the side surfaces of the ink cartridge 100 to prevent a strong impact from being directly applied to the head portion 105. The second portions 1152 of the first ribs 115 are also provided beside the head portion 105, so that the first ribs 115 can bend and absorb the impact if dropped. It is thus possible to prevent the ink cartridge 100 from being damaged at low cost without adding a new shock absorbing member.

Particularly, the first rib 115 has both a role of regulating the position of the ink cartridge 100 in the storage container 110 and a role of absorbing an impact applied to the head portion 105. The storage container 110 is provided with a plurality of the first ribs 115 to effectively acquire the above-described functions of the first rib 115. The hard main body 111 originally has a certain degree of buffering function since the side wall and the like are deformed when dropped. However, the hard main body 111 can improve drop resistance performance and reliably protect the ink cartridge 100 inside by further providing the flexible ribs 115 as described above.

### Package

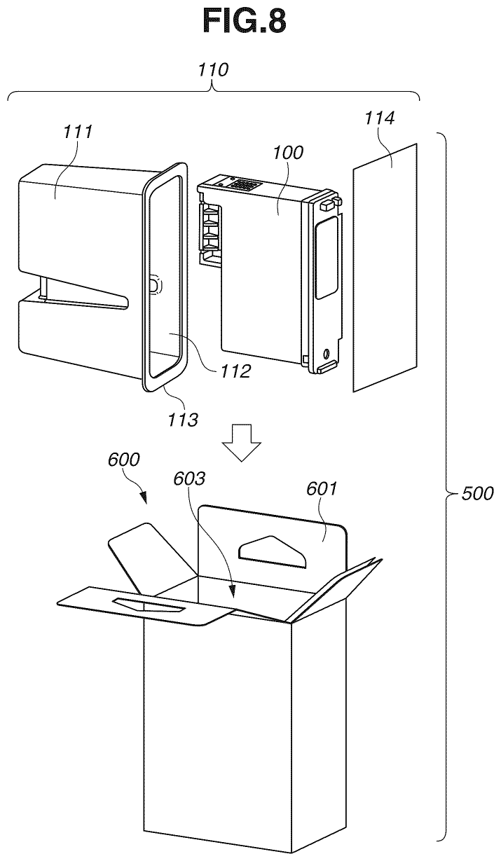

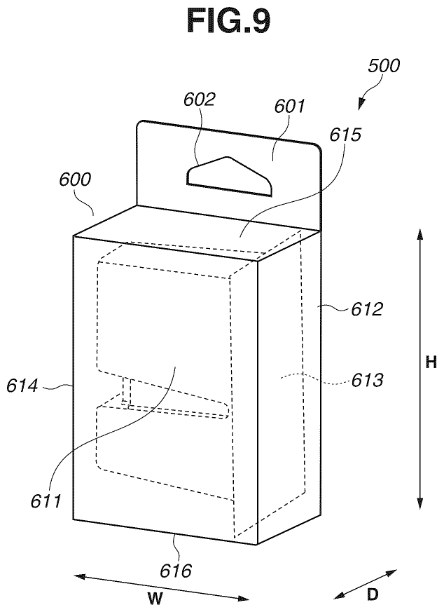

Next, an outline of a cartridge package 500 will be described with reference to FIGS. 8 and 9. FIG. 8 is an exploded perspective view of each member illustrating the package 500. FIG. 9 is an external perspective view of the package 500. In FIG. 9, the ink cartridge 100 stored inside is indicated with dotted lines. The cartridge package 500 is configured with the ink cartridge 100, the storage container 110 including the main body 111 and the lid 114, and an individual packaging box 600. The cartridge package 500 has a configuration in which the storage container 110 is included in the individual packaging box 600. The storage container 110 in the individual packaging box 600 is stored with the surface of the lid 114 facing in a direction perpendicular to the downward direction (direction of gravity) and perpendicular to a surface of a hanging flap 601.

In a case where the package 500 is displayed and sold in a store, the package 500 is in a posture in which the hanging flap 601 is upwardly located. In this posture, a size of the package 500 (the individual packaging box 600) according to the present exemplary embodiment is a rectangular parallelepiped with a height (H) of 100 mm, a width (W) of 70 mm, and a depth (D) of 48 mm, excluding the hanging flap 601, as an example. A size of the storage container 110 in the above-described posture is 92 mm in height, 64 mm in width, and 42 mm in depth.

### Individual Packaging Box

Next, the individual packaging box 600 will be described. As illustrated in FIG. 9, the individual packaging box 600 has a substantially hexahedral rectangular parallelepiped shape and includes a front surface 611, a rear surface 612, a left side surface 613, a right side surface 614, an upper surface 615, and a bottom surface 616 in an external appearance. The hanging flap 601 is provided to protrude from an edge line formed by the upper surface 615 and the rear surface 612. A hanging hole 602 is provided substantially in a center portion of the hanging flap 601.

The package 500 is intended to be hung for display in a store or the like and can be hung and displayed by inserting a hook on a shelf in the store into the hanging hole 602.

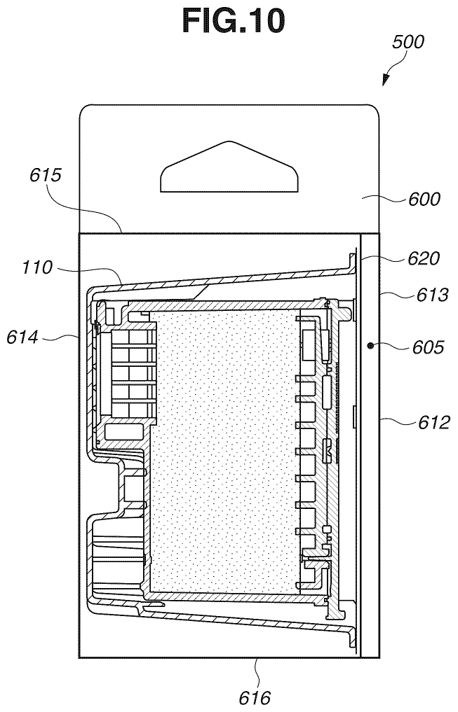

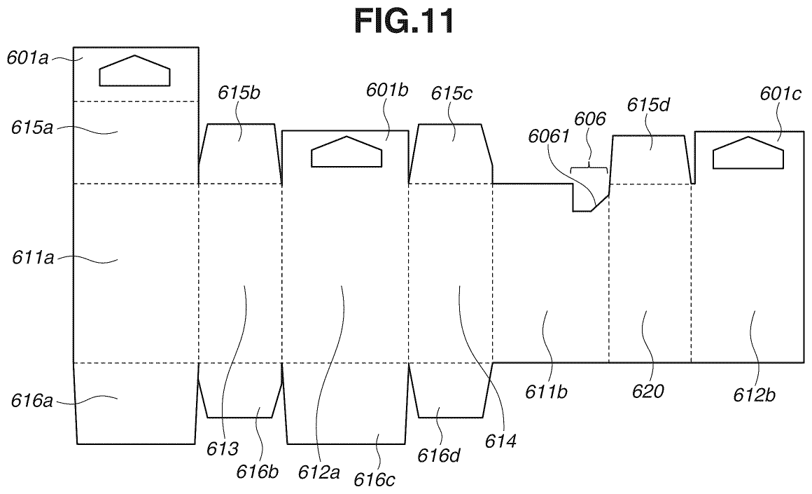

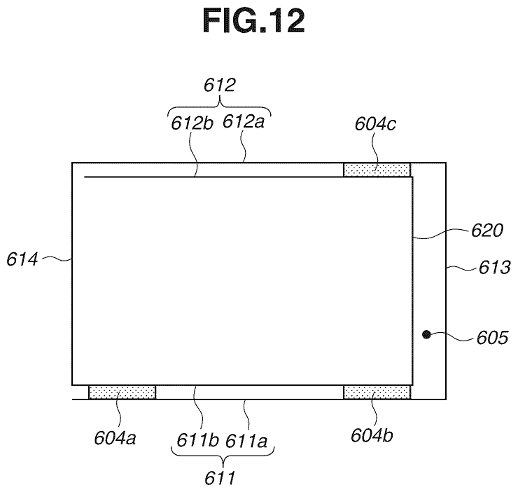

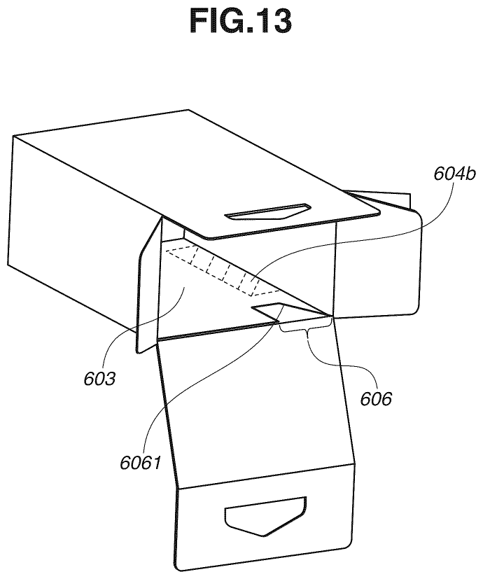

Next, an internal configuration of the individual packaging box 600 will be described. FIG. 10 is a cross-sectional view of the package 500 in a YZ plane. FIG. 11 is a development view of the individual packaging box 600. FIG. 12 is an outline drawing of the individual packaging box 600 as viewed from an opening 603, in which the hanging flap 601 and the upper surface 615 are omitted for the purpose of illustrating an inner wall 620. FIG. 13 is a perspective view of the individual packaging box 600 in a state where the opening 603 is open. The above-described ink cartridge 100 illustrated in FIGS. 1A to 1C, 4A to 4C, and 7 has a configuration including three ink reservoir chambers 104, but in FIG. 10, the ink cartridge 100 that has a configuration including one ink reservoir chamber 104 is illustrated. In this way, the storage container 110 according to the present disclosure can be applied regardless of the structure of the ink cartridge 100 to be stored therein.

As illustrated in FIG. 10, inside the individual packaging box 600, only the left side surface 613 has the inner wall 620 that is spaced apart from the left side surface 613. The storage container 110 is stored in a space (housing portion) comparted by the upper surface 615, the bottom surface 616, the front surface 611, the rear surface 612, the right side surface 614, and the inner wall 620. According to the present exemplary embodiment, a clearance 605 between the left side surface 613 and the inner wall 620 is set to 6 mm. The inner wall 620 and the clearance 605 develop a function of buffering the drop impact against the storage container 110 and therefore the ink cartridge 100. The more details will be described below.

As illustrated in FIG. 11, the individual packaging box 600 is assembled from a single sheet of paper. According to the present exemplary embodiment, a material of the individual packaging box 600 is coated cardboard with a thickness of about 0.4 mm, which is a relatively rigid paper material.

First, the single sheet of paper is folded in a rolling manner as illustrated in FIG. 12 to form the front surface 611, the rear surface 612, the left side surface 613, the right side surface 614, and the inner wall 620 of the individual packaging box 600.

The folded paper is fixed by an adhesive 604. Here, an adhesive 604a is applied to bond a front surface 611a and a front surface 611b together and to maintain and fix the individual packaging box 600 in a cylindrical shape. Further, adhesives 604b and 604c are arranged near the inner wall 620 to secure a predetermined amount (6 mm according to the present exemplary embodiment) of the clearance 605 between the left side surface 613, which is an outer wall, and the inner wall 620. Since the individual packaging box 600 is a rigid paper box as described above, the front surface 611 and the rear surface 612 that compart the clearance 605 can maintain, by providing the adhesives 604b and 604c near the inner wall 620, the clearance 605 without significantly buckling even if some impact is applied. In other words, the inner wall 620 is bonded to at least two surfaces of the individual packaging box 600 adjacent to the inner wall 620. A size of the clearance 605 in a direction perpendicular to a surface of the inner wall 620 facing the lid 114 may be 3 mm or more.

Next, bottom surfaces 616a, 616b, 616c, and 616d are folded inwardly of the cylindrical shape in order and fixed with the adhesive, so that the bottom surface 616 can be formed, and the individual packaging box 600 having the opening 603 formed on the upper surface can be assembled as illustrated in FIG. 8. The storage container 110 is then inserted from the opening 603. The opening 603 is in a surface other than a maximum area surface of the substantially rectangular parallelepiped shape of the individual packaging box 600.

As illustrated in FIGS. 11 and 13, a notch 606 is provided near the inner wall 620 and the adhesive 604b. The notch 606 is provided to improve ease of insertion of the storage container 110 into the individual packaging box 600. The lid 114 of the storage container 110 includes a projecting portion 1143 that partially project from an outer shape of the main body 111, and the projecting portion 1143 serves as a grip that can be held in peeling off the lid 114.

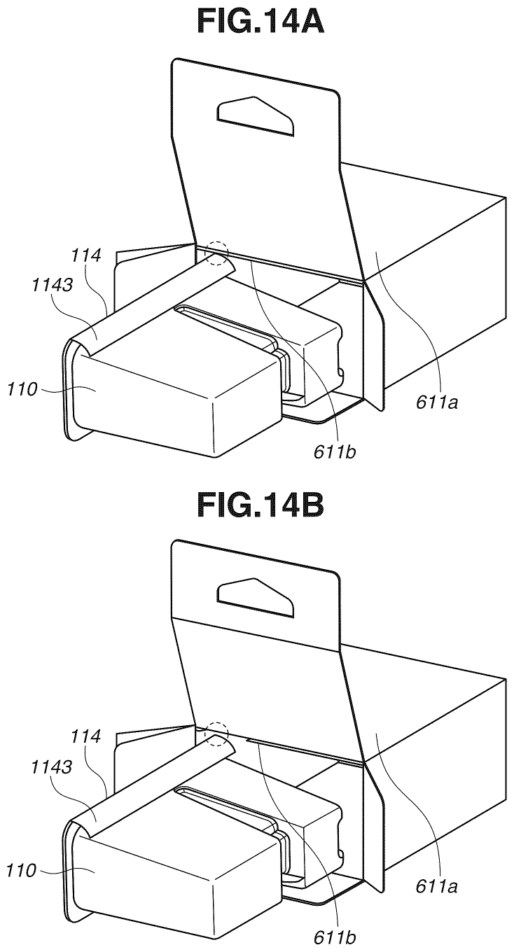

FIGS. 14A and 14B are schematic diagrams illustrating states in which the storage container 110 is inserted into the individual packaging box 600. FIG. 14A is the schematic diagram illustrating a case where the individual packaging box 600 does not have the notch 606. FIG. 14B is the schematic diagram illustrating a case where the individual packaging box 600 has the notch 606. When the storage container 110 is inserted into the individual packaging box 600, the projecting portion 1143 is bent as illustrated in FIGS. 14A and 14B.

At this time, if a notch 606 is not provided, an end of the projecting portion 1143 can come into face to face contact with an end of the front surface 611b and get caught thereon, as illustrated in FIG. 14A, which may cause insertion failure (dotted circle). In contrast, if the notch 606 is provided, as illustrated in FIG. 14B, the end of the projecting portion 1143 abuts on a slope 6061 (FIGS. 11, 13) of the notch 606. At this time, the surface of the end of the projecting portion 1143 abuts on the slope 6061 at a point, so that the projecting portion 1143 and the front surface 611b are suppressed from getting caught on the surfaces of the respective ends. After the end of the projecting portion 1143 passes through the slope 6061 of the notch 606, the end of the projecting portion 1143 is already inside the front surface 611b, so that insertion of the storage container 110 into the individual packaging box 600 becomes completed without any problem.

After the storage container 110 is inserted into the individual packaging box 600, each of upper surfaces 615a, 615b, 615c, and 615d is folded inward to form the upper surface 615. Thereafter, hanging flaps 601a, 601b, and 601c are bonded together to form the hanging flap 601, and the opening 603 on the upper surface is fixed in a closed state, so that the package 500 is completed as illustrated in FIG. 9.

### Function of Inner Wall in Dropping

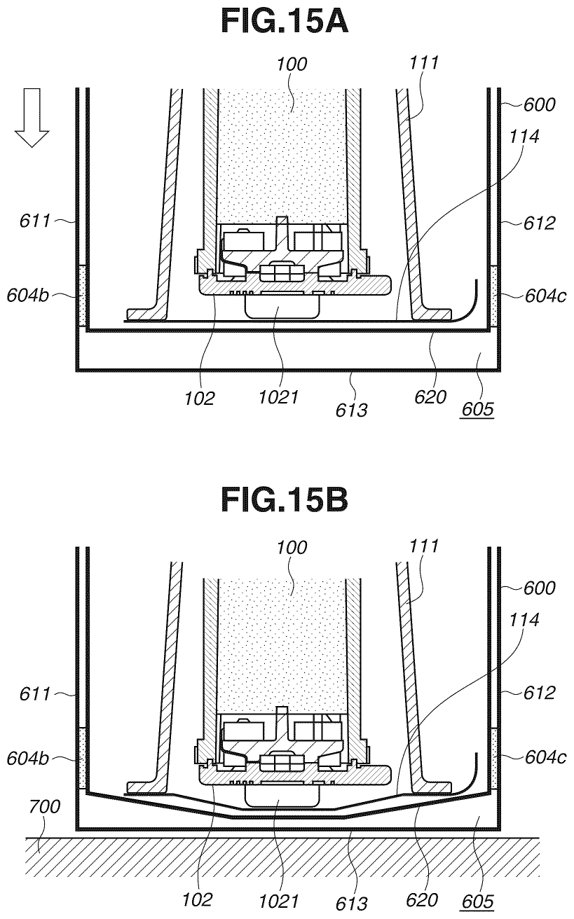

Next, a function of the inner wall 620 in dropping will be described with reference to FIGS. 15A and 15B. FIG. 15A is a cross-sectional view illustrating a state before the package 500 hits a floor surface 700 in a case where the package 500 is dropped from the left side surface 613. FIG. 15B is a cross-sectional view illustrating a state in which the package 500 hits the floor surface 700 after the state in FIG. 15A. As described above, in a posture in which the storage container 110 is dropped from the lid 114 side thereof (the left side surface 613 of the package 500), the ink cartridge 100 is more likely to receive an impact than in other postures. The inner wall 620 functions to buffer the impact of dropping from the lid 114 side (the left side surface 613 of the package 500).

A posture in which the left side surface 613 of the package 500 hits the floor surface 700 corresponds to a posture in which the lid 114 of the storage container 110 hits the floor surface 700. The inner wall 620 of the individual packaging box 600 is located near the lid 114, and the left side surface 613 is located across the clearance 605.

At the moment that the left side surface 613 of the package 500 hits the floor surface 700, a fall speed of the package 500 decelerates rapidly and approaches zero. At this time, the storage container 110 moves further downward (in the direction of gravity) due to an inertial force, but the inner wall 620 of the individual packaging box 600 receives the storage container 110 as illustrated in FIG. 15B. As described above, the inner wall 620 is bonded to the front surface 611 and the rear surface 612 and thus can hold the storage container 110 without slipping out to the left side surface 613 side.

Next, the ink cartridge 100 moves further downward by the inertial force. At this time, as described above, the protrusion of the tank lid 102 such as the engagement portion 1021 protruding furthest toward the lid 114 side (film side) presses the lid 114 of the storage container 110. The ink cartridge 100 stores a large amount of ink and thus is the heaviest unit in the package 500, so that a pressing force due to the inertial force applied to the lid 114 is also very large. If the large pressing force is applied to the lid 114, the lid 114 is deformed to be significantly convex in the downward direction. The inner wall 620 adjacent to the lid 114 is similarly deformed to be convex in the downward direction. Even when such a convex deformation occurs, a size of the clearance 605 may be set such that the clearance 605 between the inner wall 620 and the left side surface 613 is secured. Since the inner wall 620 and the left side surface 613 do not abut on each other, the ink cartridge 100 does not directly hit the floor surface 700, and thus a strong impact from the floor surface 700 in dropping is not transmitted, and the ink cartridge 100 can be protected. As described above, the individual packaging box 600 adopts a relatively thick and rigid paper material, and therefore an amount of convex deformation of the inner wall 620 can be suppressed small. Using a rigid paper material can minimize the clearance 605 that secures a space between the inner wall 620 and the left side surface 613 even if a convex deformation occurs, and also minimize an increase in size of the individual packaging box 600 in the right and left side directions.

As described above, in a case where the package 500 is dropped in a posture in which the hard main body 111 hits the floor surface 700, the flexible ribs 115 of the main body 111 absorb the drop impact and can protect the ink cartridge 100. Even in a case where the package 500 is dropped in a posture hitting the floor surface 700 from the lid 114 side where the hard main body 111 is not provided or a posture dropping from the left side surface 613, the clearance 605 between the inner wall 620 and the left side surface 613 of the individual packaging box 600 absorbs the drop impact, so that the ink cartridge 100 can be protected from the impact from the floor surface 700.

According to the above-described configuration, in a case where the package is dropped in a posture in which the hard main body hits the floor surface, the side wall and the flexible ribs of the main body can absorb a drop impact and protect the cartridge. Even in a case where the package is dropped in a posture hitting the floor surface from the lid where the hard main body is not provided, there is the clearance between the inner wall and the left side surface of the individual packaging box, so that the cartridge does not come into contact with the left side surface even if the lid and the inner wall are deformed. The cartridge can thereby be protected since a strong drop impact from the floor surface is not transmitted thereto.

A second exemplary embodiment will now be described. In the following, differences from the above-described first exemplary embodiment will mainly be described, and descriptions of portions similar to the configuration according to the first exemplary embodiment will be omitted.

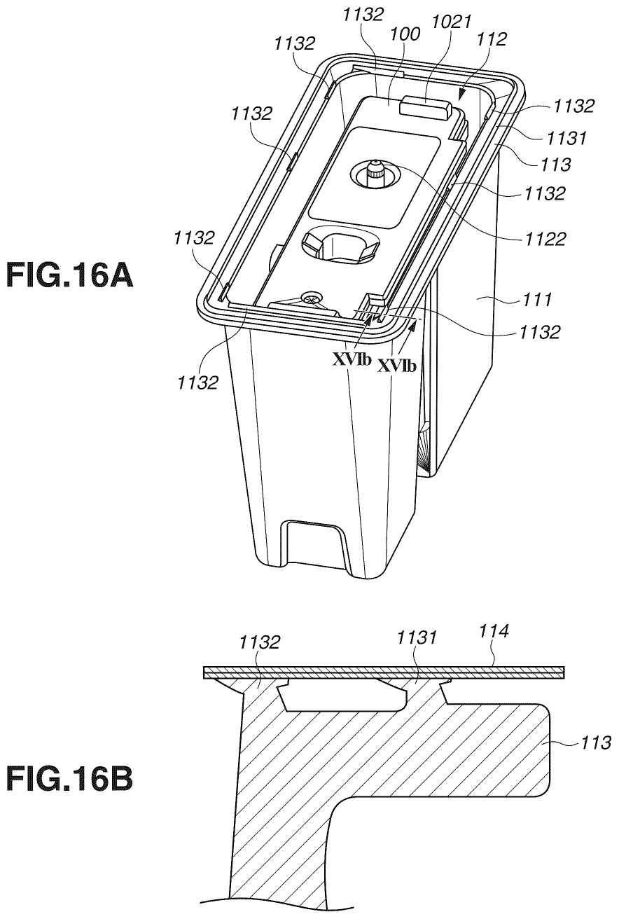

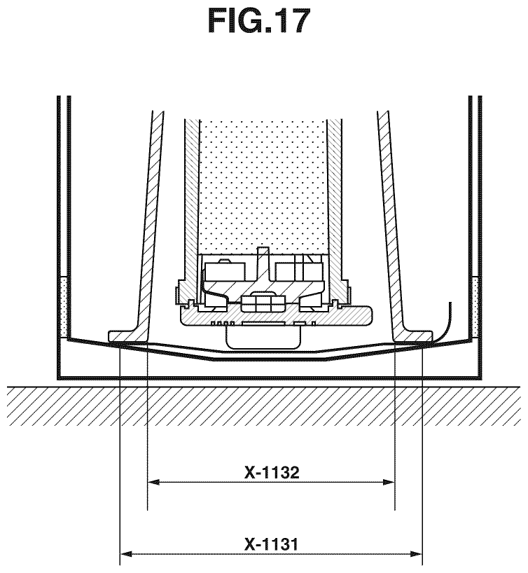

FIG. 16A is a perspective view of the main body 111 and the stored ink cartridge 100 according to the present exemplary embodiment. FIG. 16B is a cross-sectional view of the flange portion 113 of the main body 111 corresponding to a line XVIb-XVIb in FIG. 16A. FIG. 17 is a cross-sectional view of the package 500 in a state in which it drops from the left side surface 613 and hits the floor surface 700. The ink cartridge 100 illustrated in FIGS. 16A and 16B is provided with protrusions, such as the engagement portion 1021 that is used to identify stored liquid by matching with a structure of the liquid ejection apparatus and a pin 1022 that is used to position the ink cartridge with respect to the liquid ejection apparatus and to be supplied with the liquid from the liquid ejection apparatus, on the upper portion (tank lid 102). In this way, the storage container 110 according to the present disclosure can also be applied to a liquid ejection head that is configured to be supplied with liquid from a liquid tank included in a liquid ejection apparatus such as the ink cartridge 100 as illustrated in FIGS. 16A and 16B.

The second exemplary embodiment is different from the first exemplary embodiment only in a welding rib 1131 included in the main body 111 of the storage container 110. The flange portion 113 according to the present exemplary embodiment is provided with a welding inner rib 1132 on the storage portion 112 side to the welding rib 1131. The welding inner rib 1132 is provided to reduce an amount of convex deformation of the lid 114 and the inner wall 620 in the downward (gravity) direction in a case where the lid 114 side hits the floor surface 700 in dropping. In a case where two welding inner ribs 1132 are provided at positions facing each other across the storage portion 112 as illustrated in FIG. 16A, a distance between the welding inner ribs 1132 is X-1132 illustrated in FIG. 17. In other words, the distance X-1132 is an area in which the lid 114 can freely deform without being restrained and can be made shorter than a distance X-1131 in a case where the welding inner ribs 1132 are not present. By reducing the area in which the lid 114 can freely deform, it is possible to reduce the amount of convex deformation of the lid 114 and the inner wall 620 in dropping. Thus, the clearance 605 between the inner wall 620 and the left side surface 613 can also be narrowed, and a size of the package 500 in the right-and-left direction can be made smaller than that according to the first exemplary embodiment. Sealing of the storage portion 112 of the storage container 110 is maintained by welding of the welding rib 1131 as in the first exemplary embodiment. In contrast, the welding inner rib 1132 does not need to be provided over the entire circumference of the flange portion 113 and can be provided locally on the flange portion 113 as illustrated in FIG. 16A as long as it can develop a function of reducing the amount of convex deformation of the lid 114.

According to the above-described configuration, a cartridge package is provided that absorbs an impact to a liquid cartridge to be stored therein and protects the liquid cartridge.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-104683, filed Jun. 28, 2024, the entirety of which is incorporated herein by reference.

What is claimed is:

1. A cartridge package comprising:
a cartridge configured to be mounted on a liquid ejection apparatus and to store liquid;
a storage container configured with a bottom, at least four side walls, a main body, and a film, the main body including a storage portion configured to store the cartridge and an opening facing the bottom, the film being configured to seal the opening; and
a box including a substantially hexahedral housing portion configured to house the storage container,
wherein, in a state in which the storage container is housed in the box, a surface of the housing portion facing the film includes an outer wall and an inner wall separated from the outer wall by a space.

2. The cartridge package according to claim 1,
wherein the surface includes the inner wall, and
wherein the inner wall faces the cartridge.

3. The cartridge package according to claim 1, wherein the box is made of paper.

4. The cartridge package according to claim 3, wherein the box is formed by folding a single sheet of paper.

5. The cartridge package according to claim 4, wherein the inner wall is bonded to a surface of the housing portion adjacent to the inner wall.

6. The cartridge package according to claim 4, wherein the inner wall is bonded to each of two surfaces of the housing portion adjacent to the inner wall.

7. The cartridge package according to claim 1, wherein at least one side wall of the at least four side walls of the storage container includes a rib protruding in a first direction that is parallel to the bottom and inclined with respect to the at least one side wall.

8. The cartridge package according to claim 7, wherein the rib includes a first portion, and a second portion of which a protrusion length in the first direction is different from a protrusion length in the first direction of the first portion.

9. The cartridge package according to claim 1, wherein the substantially hexahedron housing portion is a substantially rectangular parallelepiped, and the opening is provided on a surface other than a surface having a maximum area of the substantially rectangular parallelepiped.

10. The cartridge package according to claim 1, wherein the film is thermally welded to the main body.

11. The cartridge package according to claim 1, wherein a size of the space in a direction perpendicular to the surface facing the film is 3 mm or more.

12. The cartridge package according to claim 1, wherein the main body is made of plastic.

13. The cartridge package according to claim 12, wherein the main body comprises a recycled plastic material.

14. The cartridge package according to claim 1, wherein the cartridge includes a protrusion protruding toward the film in a state in which the cartridge is stored in the storage portion.

15. The cartridge package according to claim 1, wherein the cartridge includes an ejection substrate provided with an ejection port for ejecting liquid.

16. The cartridge package according to claim 1, wherein the liquid contained in the cartridge is ink.

17. A manufacturing method for a cartridge package, the cartridge package including:
a cartridge configured to be mounted on a liquid ejection apparatus and to store liquid;
a storage container configured with a bottom, at least four side walls, a main body, and a film, the main body including a storage portion configured to store the cartridge and an opening facing the bottom, the film being configured to seal the opening; and
a box including a substantially hexahedral housing portion configured to house the storage container, with a surface that includes an outer wall and an inner wall separated from the outer wall by a space,
the manufacturing method comprising:
housing the storage container that stores the cartridge therein in the box such that the film faces the surface.
